(19) United States
(12) Patent Application Publication
(10) Pub. No.: US 2009/0297254 A1
(43) Pub. Date: Dec. 3, 2009

(54) Journal Template System

(75) Inventors: Carolyn J. Friend, Chicago, IL (US); James M. Weiner, Chicago, IL (US); Rebecca B. Baker, Chicago, IL (US)

Correspondence Address: BARNES & THORNBURG LLP, 600 ONE SUMMIT SQUARE, FORT WAYNE, IN, 46802, US

(73) Assignee: GEN-T LEGACY INSTITUTE, Chicago, IL (US)

(21) Appl. No.: 12/132,264

(22) Filed: Jun. 3, 2008

(51) Int. Cl. B42F 13/00; B42F 3/00; B42D 15/00; B31D 1/00

(52) U.S. Cl. 402/73; 281/15.1; 283/61; 29/592; 402/79

(57) ABSTRACT

A journaling system including a binder, journaling sheets, and template sheet. The template sheet includes a plurality of spaced holes spatially arranged to correspond to at least some of the rings in the binder. Typically, each of the holes includes a slit that allows the template sheet to be inserted and removed from the binder without opening the rings. One or more windows are defined in the template sheet which allows a user to write therethrough onto a journaling sheet. A preprinted instruction is disposed adjacent to the window which instructs the user to write a message within the window.

### TECHNICAL FIELD

This invention generally relates to a template for use in journaling; in particular, the invention relates to a template that elicits information for a journal.

### BACKGROUND

Recording events, personal thoughts, or other items that occur during the day (or other periodic basis) through a journal or diary can help create self-awareness. Existing journals typically take the form of a bound notebook or a loose-leaf binder with blank or preprinted pages inserted. The preprinted pages commonly include lines and a heading of “Diary.” This type of journal provides no help to a user in eliciting information that increases introspection.

### SUMMARY

According to one aspect, the present invention provides a journaling system with a binder, a plurality of journaling sheets, and a template sheet. The binder includes a plurality of rings operable to be selectively opened. Each of the journaling sheets includes a plurality of spaced holes along the margin that are spatially arranged to correspond to at least some of the rings in the binder. The template sheet is selectively insertable into the binder at preselected positions among the journaling sheets. The template sheet includes a margin with a plurality of holes spatially arranged to correspond with the rings in the binder. Typically each of the holes includes a slit extending to an edge of the margin so that the slits allow the template sheet to be selectively engaged about the rings without opening the rings. One or more windows are defined in the template sheet, which allows a user to write through the window(s) onto a journaling sheet. A preprinted instruction is disposed adjacent to the window which instructs the user to write a message within the window.

According to another aspect, the invention provides a template sheet for use with a binder. Typically, the template sheet includes a sheet with a margin having a plurality of holes spatially arranged to correspond with rings in the binder. In some cases, a slit may be provided in each of the holes to allow the template to be inserted and removed from the binder without opening the rings. A window may be defined in the sheet which allows the user to write therethrough. A preprinted instruction is disposed adjacent to the window, which instructs the user to write a message through the window.

According to a further aspect, the invention provides a method of forming a template sheet for use in journaling. A sheet is provided which has a margin along an edge. A plurality of holes are formed along the edge of the margin that are spatially arranged to correspond to rings in a binder. In some cases, the holes may include slits that would allow the sheet to be inserted and removed from the binder without opening the rings. One or more windows are formed in the sheet. A preprinted instruction is disposed adjacent to each of the windows. Typically, the instructions ask a user to write a message through at least one of the windows.

Additional features and advantages of the invention will become apparent to those skilled in the art upon consideration of the following detailed description of the illustrated embodiment exemplifying the best mode of carrying out the invention as presently perceived.

### BRIEF DESCRIPTION OF THE DRAWINGS

The present disclosure will be described hereafter with reference to the attached drawings which are given as non-limiting examples only, in which:

FIG. 1 is a perspective view of a journaling system according to an embodiment of the invention;

FIG. 2 is a plan view of an example template according to an embodiment of the invention;

FIG. 3 is an example loose-leaf binder with a plurality of journaling sheets and the template of FIG. 2 inserted;

FIG. 4 is the loose-leaf binder and journaling sheets shown in FIG. 3 with the template removed; and

FIG. 5 is a flowchart showing example steps that may occur to manufacture a template according to an embodiment of the invention.

Corresponding reference characters indicate corresponding parts throughout the several views. The exemplification set out herein illustrates example embodiments of the invention, and such exemplification is not to be construed as limiting the scope of the invention in any manner.

### DETAILED DESCRIPTION OF THE DRAWINGS

It is to be understood by one of ordinary skill in the art that the present discussion is a description of exemplary embodiments only, and is not intended as limiting the broader aspects of the present invention, which broader aspects are embodied in the exemplary constructions.

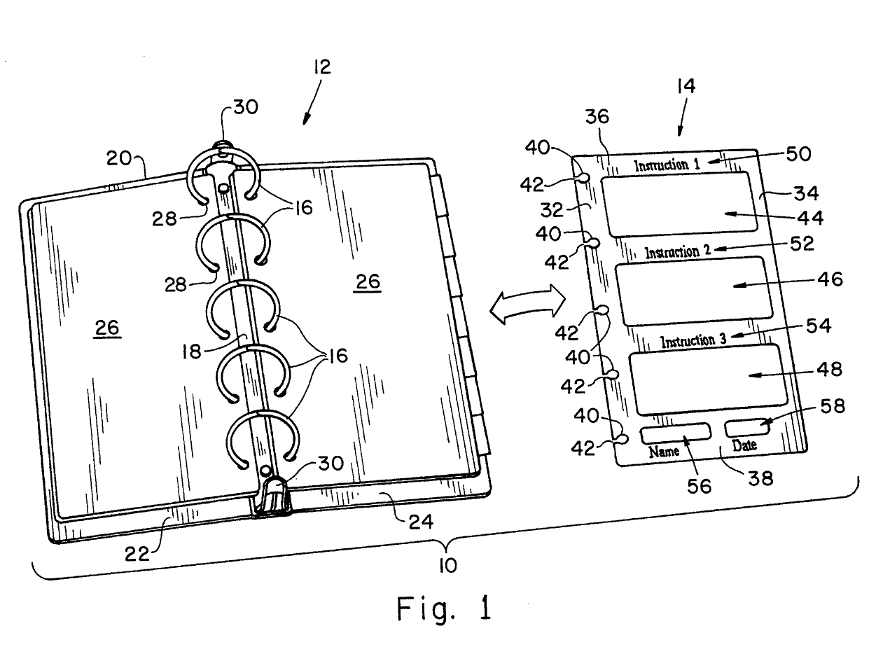

FIG. 1 shows a journaling system 10 according to an embodiment of the invention. As shown, the system 10 includes a loose-leaf binder 12 and a template 14. In this case, the example binder 12 is a conventional binder having a plurality of rings 16 mounted to a spline 18. As shown, the binder 12 is enclosed by a cover 20 having a front cover 22 and a back cover 24. The example binder 12 is shown only for illustrative purposes, but could be any suitable binder, whether loose-leaf or otherwise, having any suitable number of rings and being any suitable size. In the example shown, a plurality of journaling sheets 26 are held within the binder 12. The sheets include holes 28 that are spatially arranged to be received by the rings 16. The rings 16 are opened by moving levers 30 so that sheets 26 can be added or removed. Although this example shows the sheets 26 as being entirely blank, it should be appreciated that the sheets may include lines, graphics, or other textual information as desired.

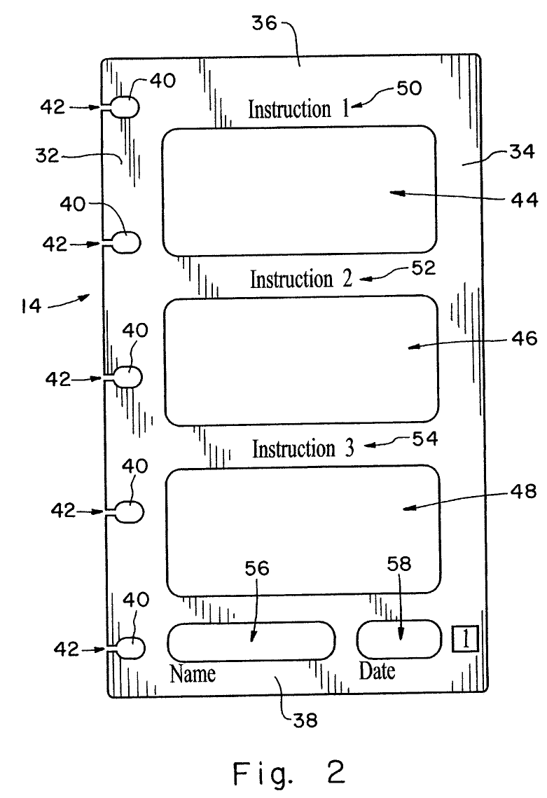

Referring now to both FIGS. 1 and 2, the template 14 elicits information from a user. Although the template 14 is typically a paper sheet or card stock, the template 14 could be a sheet formed from plastic or other suitable material. As shown, the template 14 includes a left margin 32, a right margin 34, a top margin 36, and a bottom margin 38. In the embodiment shown, the left margin 32 includes a plurality of holes 40 that are spatially arranged to engage the rings 16 on the binder 12. Although this example shows the holes 40 on the left margin, it should be appreciated that the holes could be on the right margin 34, top margin 36, or bottom margin 38, depending on the configuration of the binder to which the template 14 was configured to be inserted. It should be appreciated that the number of holes 40 could vary depending on the number of rings 16 on the binder 12.

In the embodiment shown, each of the holes 40 includes a slit 42 extending between the holes 40 and the edge of the left margin 32. The slits 42 allow the template 14 to be inserted into the binder 12 without the necessity of opening the rings 16. For example, the slits 42 may be forcibly pressed against the rings 16 which cause the respective holes 40 to receive the rings 16. In some embodiments, the slits 42 do not necessarily need to be aligned with the rings 16. Other embodiments are contemplated in which the holes 40 and slits 42 may be optional. For example, the template 14 may include a releasable adhesive, similar to the adhesive on a Post-it™ note, that would allow the user to releasably affix the template 14 to one of the sheets 26. In another embodiment, the binder 12 or template 14 could include a clip that could fix the position of the template 14 with respect to the sheets 26. In such an embodiment, the clip could be disposed on the top, bottom or a side of the binder 12 or template 14.

The template 14 includes one or more windows through which the user may use to write comments directly on the sheets 26. In this example, the template 14 includes a first window 44, a second window 46, and a third window 48. Although three windows are shown in the example template 14, it should be appreciated that a single window, two windows, or more than three windows could be provided on the template 14. Preferably, each window has a major dimension that is greater than 4 inches and a minor dimension that is greater than 1 inch, depending on the size of the sheets 26. The term “major dimension” means the greater of either the length or width. The term “minor dimension” refers to the smaller dimension of either the length or width. Typically, the major dimension of at least one window will be greater than at least half the minor dimension of the template 14. In some cases, the major dimension of at least one window will be greater than 70% of the minor dimension of the template 14. In the example shown, the windows 44, 46, 48 have approximately the same major dimension. Although this is shown for purposes of illustration, it should be appreciated that embodiments are contemplated in which the major dimension of the windows could differ. As shown, the minor dimension of the windows 44, 46, 48 differs between the windows 44, 46, 48. It should be appreciated, however, that the minor dimension could be the same for each of the windows 44, 46, 48 if desired.

In the embodiment shown, a first instruction 50, a second instruction 52, and a third instruction 54 are associated with the first window 44, second window 46, and third window 48, respectively. Preferably, the instructions 50, 52, 54 are preprinted instructions that elicit specific information to be written into the window that is associated with that instruction. For example, a user would write information into the first window 44 that is elicited from the first instruction 50. Information elicited from the second instruction 52 would be written into the second window 46. Likewise, the user would write information elicited from the third instruction 54 into the third window 48.

In some instances, the first instruction 50 may elicit the user to describe a personal experience or event into the first window 44. By purposes of example only, the first instruction 50 could be: “Write about an interaction that took place or one you observed. It can be big or small. Capture the event, observation, or happening in the window.” In some cases, the second instruction 52 could elicit the user to provide more details about the personal experience or event described in the first window 44 into the second window 46. For example, the second instruction 52 could be: “Relationships, details or fine points are part of the experience or make it stand out for you. Write them in the window.” In some embodiments, the third instruction 43 could ask the user to provide any guiding principals that were learned from the event or experience into the third window 48. By way of example, the third instruction could be: “Each of us is guided by our traditions and our beliefs. Write one guiding principle that is part of this experience or observation in the window.” In the embodiment shown, a name window 56 and date window 58 are also provided for the user to identify himself and the current date in which he/she wrote the information.

By way of another example, consider an embodiment in which the template 14 includes instructions intended to develop and enhance relationships. In such an embodiment, the template may include a header stating “Life is about sharing. Choose an experience that you and someone important to you were at or involved in.” The first instruction 50, which may be above, below or beside the first window 44, could be: “Capture the experience and what stood out for you in the box below.” In some cases, the second instruction 52, which may be above, below or beside the second window 46, could state “This is where we connect . . . Sharing builds flourishing connections.” In some embodiments, the third instruction 43 could be: “have a conversation with the person who shared the experience. Write their perspective in the box . . . (or if you choose) have them fill in the box themselves.”

By way of a further example, consider an embodiment in which the template 14 includes instructions intended to allow teens to write about their experiences, during the school year, on vacation or at camp. The first instruction 50, which may be above, below or beside the first window 44, could be: “Many things happen to you during the day. Write about one experience big or small that affected the way you are feeling or thinking about something.” In some cases, the second instruction 52, which may be above, below or beside the second window 46, could state “Write the names the people present. Or write about the details of the environment that stand out for you.” In some embodiments, the third instruction 43 could be: “Each of us is guided by things we have been taught or heard (guiding principles) . . . write one that is in this situation.”

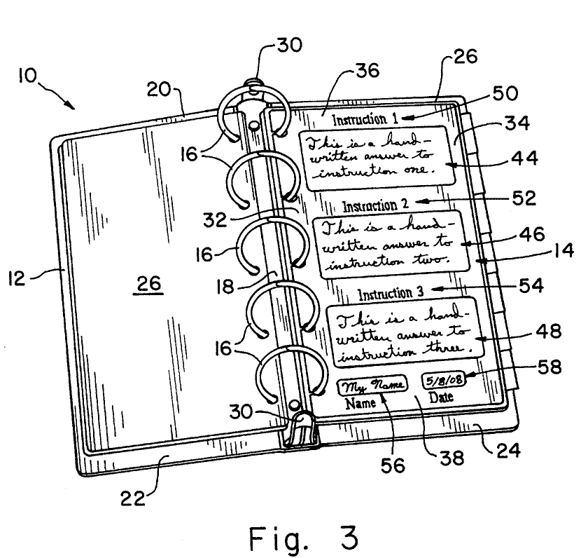

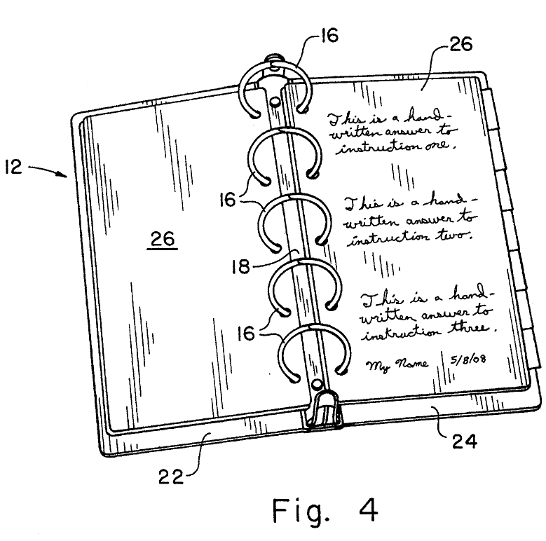

FIGS. 3 and 4 illustrate an example of how the template 14 could be used according to one embodiment. In FIG. 3, the template 14 has been inserted into the binder 12 so that a sheet 26 is disposed below the template 14. After the user inserts the template into the desired location of the binder 12, the user may handwrite in information that has been elicited from the first, second, and third instructions 50, 52, 54 into the respective windows 44, 46, 48. Likewise, the user may sign or print her/his name in the name window 56 and date the entry using the date window 58. FIG. 4 shows the entry after the template 14 has been removed from the binder.

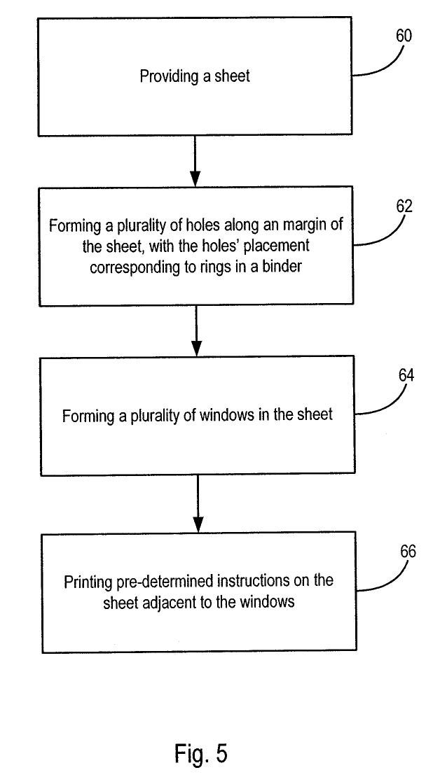

FIG. 5 shows a flowchart with example steps that may occur to manufacture the template 14 according to an embodiment of the invention. In this embodiment, a substantially blank sheet, such as a card stock, paper sheet, or plastic sheet, is provided, as shown in step 60. A plurality of holes are formed along an edge of the sheet, with each hole being spatially aligned to correspond with rings and a binder into which the template is intended to be inserted, as shown in step 62. For example, the holes may be punched or otherwise formed in the sheet. As mentioned above, the holes typically include a slit to facilitate easy insertion and removal of the template into a binder. A plurality of windows are formed in the sheet, such as by punching out areas of the sheet, as shown in step 64. Instructions are printed on the sheet adjacent to the position of each window, as shown in step 66. It should be appreciated that steps 62, 64, and 66 could be performed in any order and should not be limited to a sequential order.

Although the present disclosure has been described with reference to particular means, materials, and embodiments from the foregoing description, one skilled in the art can easily ascertain the essential characteristics of the invention and various changes and modifications may be made to adapt the various uses and characteristics without departing from the spirit and scope of the invention.

What is claimed:

1. A journaling system comprising:
a binder having a plurality of rings operable to be selectively opened;
a plurality of journaling sheets having a plurality of spaced holes along a margin, wherein the holes spatially correspond to the rings so the journaling sheets may be selectively engaged with the rings of the binder;
a template sheet selectively insertable into the binder at pre-selected positions among the journaling sheets, wherein the template sheet comprises:
a margin along an edge of the template sheet with a plurality of spaced holes spatially corresponding to at least a plurality of the rings, each of the holes including a slit extending to the edge of the margin, the slits allowing the holes to be selectively engaged about the rings without opening the rings;
a window defined in the template sheet, wherein the window allows a user to write therethrough onto a journaling sheet when the template sheet is selectively engaged with the rings of the binder; and
a preprinted instruction adjacent the window in the template sheet, wherein the preprinted instruction instructs a user to write a message within the window.

2. The journaling system of claim 1, wherein the template sheet includes a first window associated with a first preprinted instruction and a second window associated with a second preprinted instruction.

3. The journaling system of claim 2, wherein the first preprinted instruction is disposed above the first window and the second preprinted instruction is disposed above the second window.

4. The journaling system of claim 2, wherein a major dimension of the first window and a major dimension of the second window are substantially the same.

5. The journaling system of claim 4, wherein the major dimension of the first window and the major dimension of the second window is greater than half of a minor dimension of the template sheet.

6. The journaling system of claim 5, wherein the major dimension of the first window and the major dimension of the second window is at least 70% of the minor dimension of the template sheet.

7. The journaling system of claim 4, wherein the major dimension of the first window and the major dimension of the second window is greater than four inches.

8. The journaling system of claim 7, wherein a minor dimension of the first window and a minor dimension of the second window is greater than one inch.

9. The journaling system of claim 2, wherein the template sheet includes a third window associated with a third preprinted instruction.

10. The journaling system of claim 9, wherein a major dimension of the third window is substantially the same as a major dimension of the first window and a major dimension of the second window.

11. The journaling system of claim 10, wherein the first window, the second window and the third window are vertically aligned.

12. The journaling system of claim 9, wherein the first preprinted instruction instructs a user to write a description of an experience observed by the user onto a journaling sheet through the first window in the template sheet.

13. The journaling system of claim 12, wherein the second preprinted instruction instructs the user to write additional details of the experience onto the journaling sheet through the second window in the template sheet.

14. The journaling system of claim 13, wherein the third preprinted instruction instructs the user to write a guiding principle that is part of the experience onto the journaling sheet through the third window in the template sheet.

15. A template sheet for use with a binder, the template sheet comprising:
a sheet having a margin along an edge with a plurality of spaced holes spatially corresponding to rings in a binder, each of the holes including a slit extending to the edge of the margin;
a window defined in the sheet, wherein the window allows a user to write therethrough; and
a preprinted instruction adjacent the window in the sheet, wherein the preprinted instruction instructs a user to write a message through the window.

16. The template sheet of claim 15, wherein the sheet includes a first window associated with a first preprinted instruction and a second window associated with a second preprinted instruction, wherein the first preprinted instruction instructs a user to write a message through the first window and a second preprinted instruction instructs a user to write a message through the second window.

17. The template sheet of claim 16, wherein a major dimension of the first window and a major dimension of the second window is greater than four inches.

18. The template sheet of claim 17, wherein a minor dimension of the first window and a minor dimension of the second window is greater than one inch.

19. A method of forming a template sheet for use in journaling, the method comprising the steps of:
providing a sheet having a margin along an edge;
forming a plurality of holes along the edge of the margin that are spatially corresponding to rings in a binder, wherein each of the holes includes a slit extending to the edge of the margin;
forming a plurality of windows in the sheet; and
printing predetermined instructions on the sheet adjacent to each of the windows, wherein at least one of the instructions instructs a user to write a message through at least one of the windows.

20. The method of claim 19, wherein the sheet is formed from at least one of paper and plastic.

21. A journaling system comprising:
a binder having a plurality of rings operable to be selectively opened;
a plurality of journaling sheets having a plurality of spaced holes along a margin, wherein the holes spatially correspond to the rings so the journaling sheets may be selectively engaged with the rings of the binder;
a template sheet operable to be selectively placed in a fixed position with respect to the journaling sheets, wherein the template sheet comprises:
a window defined in the template sheet, wherein the window allows a user to write therethrough onto a journaling sheet when the template sheet is selectively engaged with the rings of the binder; and
a preprinted instruction adjacent the window in the template sheet, wherein the preprinted instruction instructs a user to write a message within the window.

22. The journaling system of claim 21, wherein the template sheet includes a releasable adhesive portion adapted to releasably secure the template sheet to at least one of the journaling sheets.

23. The journaling system of claim 21, wherein at least one of the template sheet and the binder includes a clip adapted to releasably fix a position of the template with respect to the journaling sheets.

24. The journaling system of claim 21, wherein the template sheet includes a first window associated with a first preprinted instruction and a second window associated with a second preprinted instruction.

25. The journaling system of claim 24, wherein the major dimension of the first window and the major dimension of the second window is greater than half of a minor dimension of the template sheet.

26. The journaling system of claim 25, wherein the template sheet includes a third window associated with a third preprinted instruction, wherein a major dimension of the third window is substantially the same as the major dimension of the first window and the major dimension of the second window.

27. The journaling system of claim 26, wherein the first window, the second window and the third window are vertically aligned.

28. The journaling system of claim 26, wherein the first preprinted instruction instructs a user to write a description of an experience observed by the user onto a journaling sheet through the first window in the template sheet.

29. The journaling system of claim 28, wherein the second preprinted instruction instructs the user to write additional details of the experience onto the journaling sheet through the second window in the template sheet.

30. The journaling system of claim 29, wherein the third preprinted instruction instructs the user to write a guiding principle that is part of the experience onto the journaling sheet through the third window in the template sheet.

31. A method of forming a template sheet for use in journaling, the method comprising the steps of:
providing a sheet formed from at least one of paper and plastic;
forming a plurality of windows in the sheet; and
printing predetermined instructions on the sheet adjacent to each of the windows, wherein at least one of the instructions instructs a user to write a message through at least one of the windows.
